(19) United States
(12) Patent Application Publication
(10) Pub. No.: US 2013/0056232 A1
(43) Pub. Date: Mar. 7, 2013

(54) Golf hole cutter

(71) Applicant: Thomas Rahm, Truman, MN (US)

(72) Inventor: Thomas Rahm, Truman, MN (US)

(21) Appl. No.: 13/507,236

(22) Filed: Jun. 14, 2012

Related U.S. Application Data
(60) Provisional application No. 61/520,752, filed on Jun. 14, 2011.

(51) Int. Cl. A01B 45/00

(52) U.S. Cl. 172/22

(57) ABSTRACT

A hole cutter tool reduces strain on a worker changing a hole location on a golf course or putting green, while also enabling more efficient replacement of turf into the old hole. The hole cutter employs a plurality of arced cutting plates, each of which is driven by an external portable driving device.

### PRIORITY CLAIM

This application claims priority to U.S. provisional patent application No. 61/520,752 entitled “Golf Hole Cutter” and filed on Jun. 14, 2011.

### FIELD OF THE INVENTION

The present invention relates to the game of golf. More particularly, the present invention relates to a tool for cutting a hole on a golf course or putting green.

### BACKGROUND OF THE INVENTION

To vary the experience of playing a particular golf course, pin locations on the greens may be moved from time to time. Moving a pin location typically requires extracting a cylindrical section of turf from the new hole location and inserting the section in the previous hole location so that the surface of the putting green is smooth once the section is inserted. This chore is often done with simple hand tools.

### BRIEF DESCRIPTION OF THE INVENTION

A hole cutter tool reduces strain on a worker changing a hole location on a golf course or putting green, while also enabling more efficient replacement of turf into the old hole. The hole cutter employs a plurality of arced cutting plates, each of which is driven by an external portable driving device.

### BRIEF DESCRIPTION OF THE DRAWINGS

The accompanying drawings, which are incorporated into and constitute apart of this specification, illustrate one or more embodiments of the present invention and, together with the detailed description, serve to explain the principles and implementations of the invention.

In the drawings:

FIG. 1 depicts a prototype of the hole cutter with cutting plates in the retracted position.

FIG. 2 depicts a prototype of the hole cutter with an external driving tool connected to the driver adapter of a fixed screw.

FIG. 3 depicts a prototype of the hole cutter with one of the cutting plates in the extended position.

FIG. 4 is a mechanical drawing of the hole cutter.

FIG. 5 shows the stabilizer plate with bearings and a fixed screw rod.

FIG. 6 shows the stabilizer plate and screw rod superimposed over FIG. 4.

FIGS. 7-10 are mechanical drawings showing various details of the invention.

FIG. 11 shows an embodiment of a depth guide system.

### DETAILED DESCRIPTION

Embodiments of the present invention are described herein in the context of a golf hole cutter. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

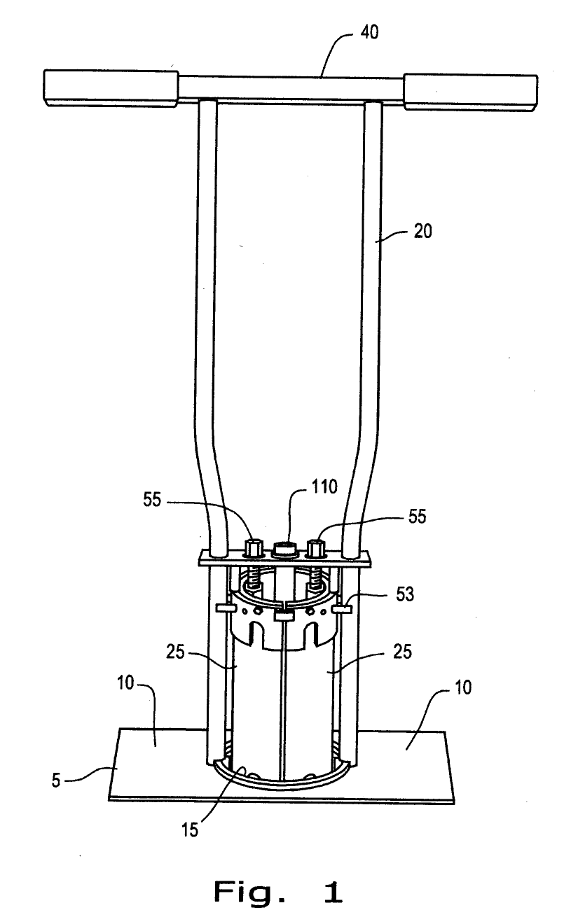

The invention is a golf hole cutter. Referring to FIGS. 1-3, the hole cutter comprises a planar base plate 5, said base plate 5 having one or two foot pressure surfaces 10, and said base plate defining an aperture 15. A handle 20 is fixedly attached to the base plate and extends upward from the base plate. The hole cutter has a plurality of arced cutting plates 25, the plurality of plates together defining a cylinder, each of said plates mounted on the tool to allow vertical motion of the plate through the aperture. The hole cutter has a plurality of fixed screw rods 30, each of the screws mounted vertically and connected with a cutting plate so that rotation of a screw drives the vertical motion of the connected cutting plate. The handle 20 may comprise two vertical elements 35 and a horizontal element 40 on the top. The hole cutter may further comprise a horizontal bracket 45 mounted between the vertical elements 35 and located between the base plate 5 and the horizontal element 40, where the bracket 45 defines apertures fixing and accommodating the upper ends of the fixed screw rods. The hole cutter may further comprise a plurality of arced supports 50, each of said arced supports 50 providing a rigid mount to a corresponding cutting plate 25 and communicating with a corresponding fixed screw rod 30 so that rotation of the screw results in vertical motion of both the arced support and the cutting plate. The top of each of the fixed screw rods may comprise a driver adapter 55.

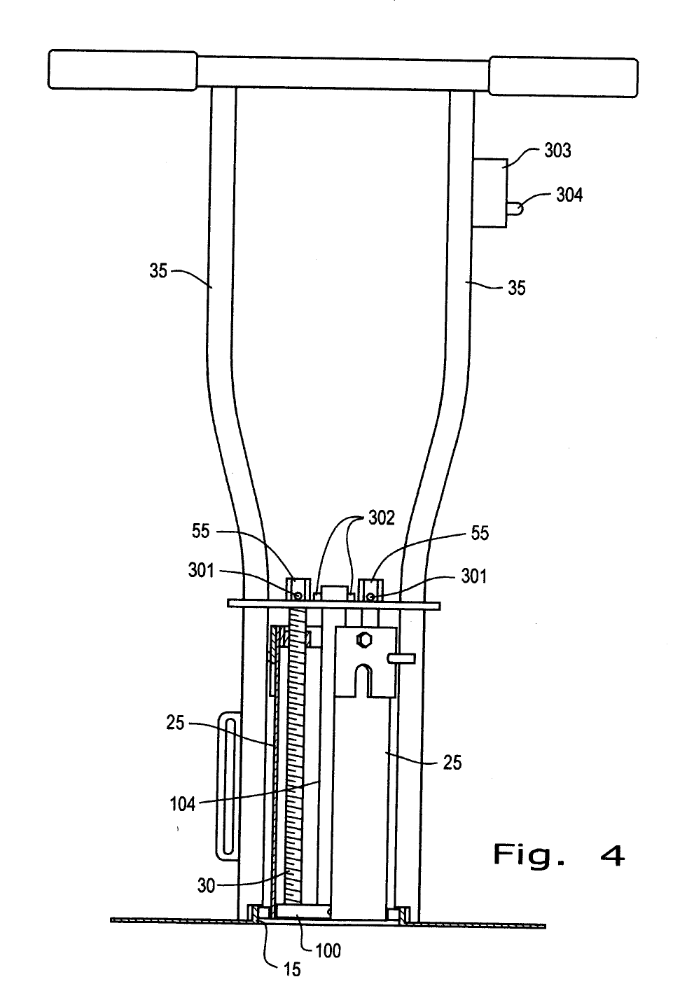

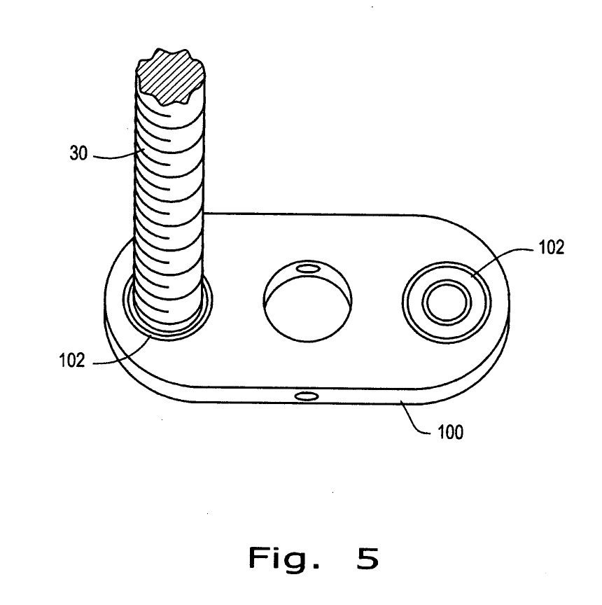

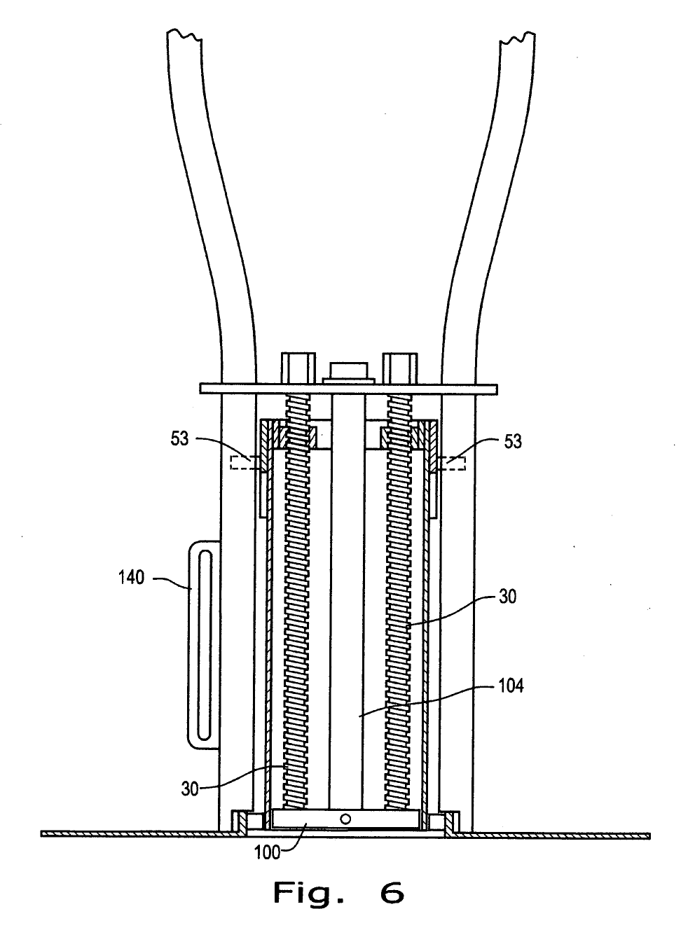

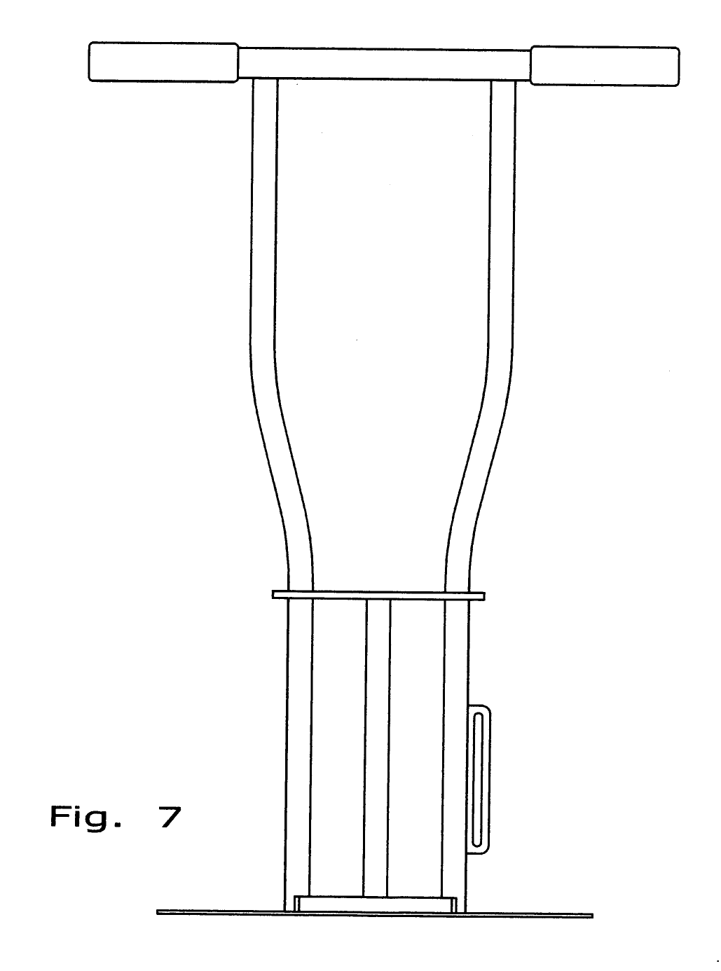

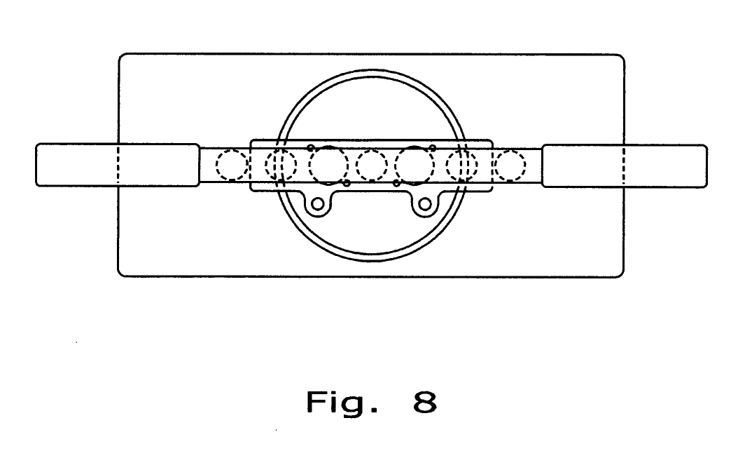

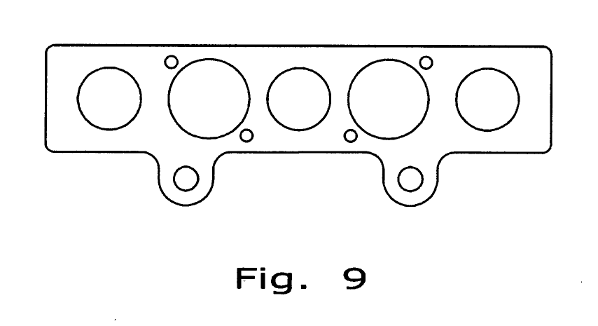

Referring now to FIGS. 5 and 6, the hole cutter may further comprise a stabilizer plate 100. The stabilizer plate has bearings 102 for supporting the lower ends of the fixed drive screws 30. The plate is rigidly connected to horizontal bracket 45 via a connecting rod 104 (see FIG. 4). The stabilizer plate provides several functions. By fixing the lower end of the drive screws, with the upper ends fixed by the horizontal bracket, the drive screws can be rotated securely. The oblong circular shape of the plate has rounded edges that serve as internal guides for the moving cutting plates. Further, the plate is shaped so as not to fill the entire cutting cylinder. By providing spaces between the stabilizer plate and the cutting plates, loose soil and sand can easily be cleaned out of the tool.

The stabilizer plate stabilizes the cutting plates from the inside at the lower end of the tool. Additional stabilization at the lower end may be obtained by including an external support ring around the aperture of the base plate. The ring surrounds the cylinder defined by the cutting plates. In such a configuration, the cutting plate is supported internally by the stabilizer plate and externally by the external support ring. At its upper end, each cutting plate is stabilized by attachment to an arced support. Further stabilization may be obtained by including one or more guide pins between each arced support and the handle.

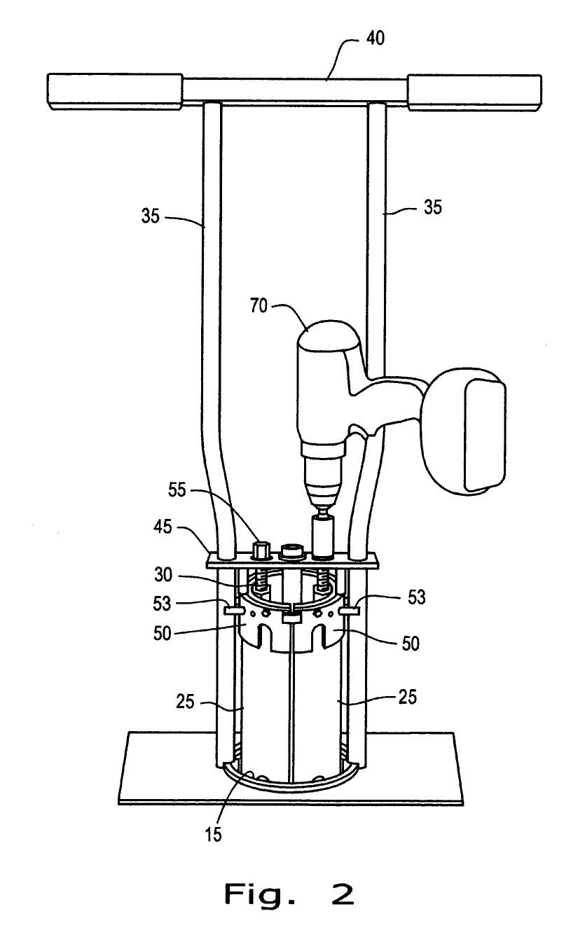

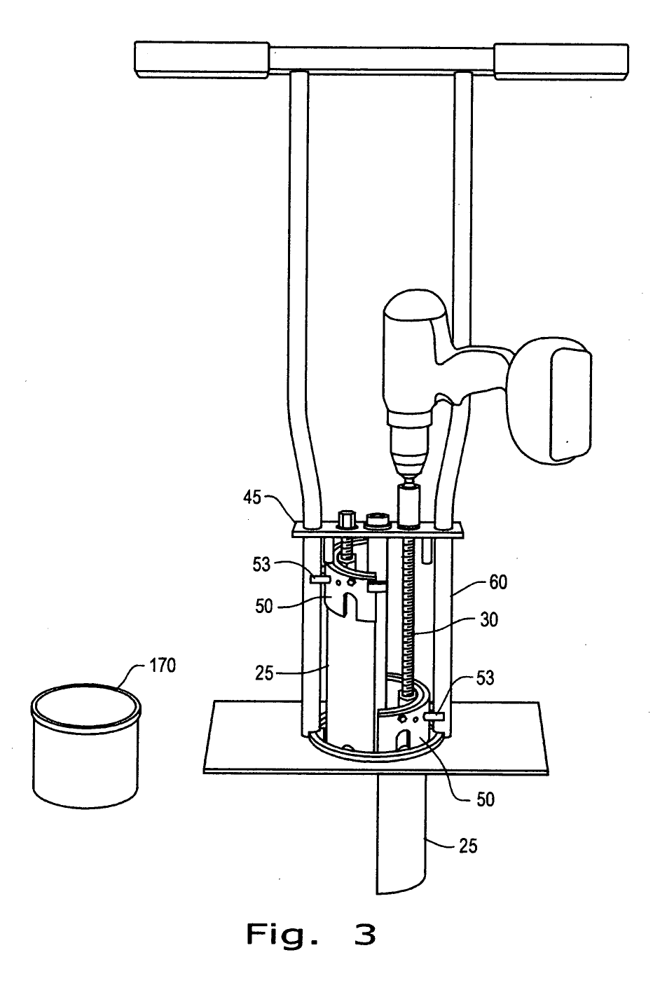

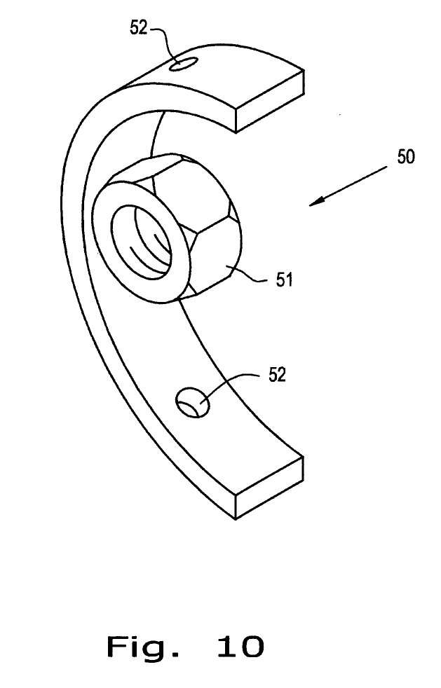

Cutting plates are preferably made from seamless steel tubing having the appropriate diameter. The tubing is cut precisely into arced segments, and then heat treated to reduce wear and anodized to prevent rust. The cutting plates are each preferably secured in the tool with an arced support 50 (see FIGS. 2 and 10). Each arced support is interposed between a fixed screw rod and a cutting plated. The arced support includes a threaded adapter 51 for the screw rod and apertures 52 or other fastening means for removably securing a cutting plate. The arced support may also include, guide pins 53 (FIGS. 2 and 3), that communicate with the handle and further stabilize the movement of the cutting plates.

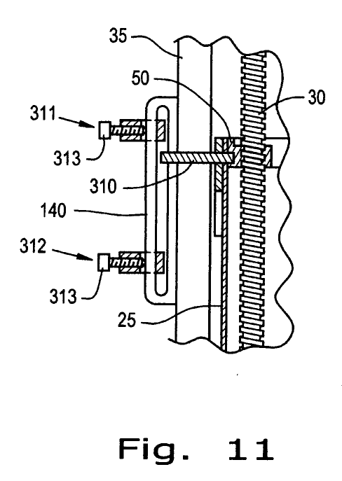

Over time, the lower edges of the cutting plates will wear away with use. Two features have been designed into the invention to address this issue. First, the cutting plates are easy to replace. A user simply has to unfasten the worn cutting plate from the arced support and attach a new one. Second, a depth guide system may be included to calibrate the movement of a cutting relative to the amount of wear of the cutting plate. Referring to FIG. 11, a new cutting plate 25 may be nine inches long. A gauge pin 310 attached to each arced support 50 communicates with a guide bar 140. When the plate is new, the range of motion of a cutting plate is from the lower surface of the base plate to the intended bottom of the golf hole about seven inches). The guide bar is attached to vertical element 35 and has an adjustable upper stop 311 and an adjustable lower stop 312. The stops may comprise set screws 313 or the like. Initially, the upper and lower stops are set to support the initial range of motion of the cutting plate. As the lower edge of the cutting plate wears away, the stops are adjusted to correctly position the upper and lower limits of the range of motion of the cutting plate.

As an alternative to the guide bar/gauge pin mechanism, a sensor system may be implemented to ensure that hole are drilled to the correct depth. Referring to FIG. 4, in one embodiment of the sensor system, magnet 301 is attached to or embedded in the outer portion of each of the fixed screw rods 30 so that the attached magnet revolves as each screw rod is turned. The magnet 301 is located near the top of each screw rod 30 near driver adapter 55. One or more detectors 302 are located to detect revolution of the magnets. The detector communicates with signal box 303. Signal box 303 counts the number of revolutions and activates signal 304 when the cutting plate has reached the proper depth. The signal may comprise a light, a buzzer, or a signal to power of the drill driver. Calibration of the system may be done by periodic maintenance of the tool to ensure that the bottom edges of the cutting plates are adjusted to always begin the drilling process from the same point.

The hole cutter assembly may further comprise a cup 70 for containing a turf cylinder extracted by the hole cutter. The hole cutter may include a bulls-eye type level (110 in FIG. 1).

The invention has been illustrated in a preferred embodiment having two cutting plates, and correspondingly two arced supports and two fixed screw rods. However, the invention also includes embodiments having more than two of each of these components.

Standard golf holes are 4.25 inches in diameter and have a depth of at least 4 inches (typically 7 inches deep). The hole cutter of the present invention preferably is dimensioned to create standard holes. Therefore, the base plate is between about 12 and 20 inches in width, between about 6 and 8 inches in depth (front to back), and between about 114 and 318 inches in thickness. The hole cutter is preferably made of metal for strength and durability, and preferably weighs less than about 30 pounds

To operate the hole-cutting tool, a user places the tool over the location of the new hole. Using a drill driver 70, the user drives the cutting plates into the ground one at a time while applying foot pressure to the base plate. When all the cutting plates are fully extended, the user removes a cylindrical soil plug with a lifting and twisting motion. The plug is placed into the cup, and moved to the old hole location and inserted.

Advantages of the tool include allowing for uniform plug cutting, so that a minimum amount of adjustment is needed when inserting a plug into the old hole location. The tool also is ergonomically advantageous to the user as compared to current technologies.

Many design variations are possible within the scope of the invention. One or more drill drivers may be incorporated into the tool, so that driver adapters are not needed. The cutting plates and arced supports may be integrally formed. Arced supports may include further components such as guide pins and gauge pins, which may be integrally formed. The device may have a single foot pressure surface, though two are preferred. While the device has been illustrated with two cutting plates and associated hardware, it is within the scope of the invention to provide a tool with three or more cutting plates and associated hardware. The cutting plates are preferably made out of steel or tin, and are replaceable. The fixed screw rods are shown preferably mounted within the cylinder, though they could less optimally be mounted outside the cylinder.

In one aspect, the invention is a golf hole cutter. The hole cutter comprises: a planar base plate, said base plate having one or two upper foot pressure surfaces and a lower surface, and said base plate defining an aperture; a handle fixedly attached to the base plate and extending upward from the base plate, where the handle comprises two vertical elements and a horizontal element on the top; a plurality of arced cutting plates, the plurality of plates together defining a cylinder, each of said plates movably mounted to allow vertical motion of the plate through the aperture; a plurality of fixed vertical screw rods, each of the screw rods connected with a cutting plate so that rotation of the screw rod drives the vertical motion of the connected cutting plate; a horizontal bracket mounted between the vertical elements of the handle and located between the base plate and the horizontal element of the handle, where the bracket defines apertures accommodating and fixing the upper ends of the fixed screw rods; and a stabilizer plate located within the cylinder defined by the cutting plates, said stabilizer plate having a lower horizontal surface fixed at about the same level as the lower surface of the base plate

The hole cutter may further comprise a plurality of arced supports, each of said arced supports providing a rigid mount to a corresponding cutting plate and communicating with a corresponding fixed screw rod so that rotation of the screw results in vertical motion of both the arced support and the cutting plate. The top of each of the fixed screw rods may comprise a driver adapter.

The hole cutter may further comprising a depth gauge system for regulating the depth that a cutting plate may extend below the aperture of the base plate. The stabilizer plate may be secured in place to the horizontal bracket via a connecting rod, and the stabilizer plate may include bearings for supporting the lower end of each fixed drive screw.

While embodiments and applications of this invention have been shown and described, it would be apparent to those skilled in the art having the benefit of this disclosure that many more modifications than mentioned above are possible without departing from the inventive concepts herein. Implementation of the invention may include variations and permutations of features selected from either or both of the two embodiments shown in detail of this disclosure. The invention, therefore, is not to be restricted except in the spirit of the appended claims.

What is claimed is:

1. A golf hole cutter, said hole cutter comprising:
a planar base plate, said base plate having one or two upper foot pressure surfaces and a lower surface, and said base plate defining an aperture;
a handle fixedly attached to the base plate and extending upward from the base plate, where the handle comprises two vertical elements and a horizontal element on the top;
a plurality of arced cutting plates, the plurality of plates together defining a cylinder, each of said plates movably mounted to allow vertical motion of the plate through the aperture;
a plurality of fixed vertical screw rods, each of the screw rods connected with a cutting plate so that rotation of the screw rod drives the vertical motion of the connected cutting plate;
a horizontal bracket mounted between the vertical elements of the handle and located between the base plate and the horizontal element of the handle, where the bracket defines apertures accommodating and fixing the upper ends of the fixed screw rods; and
a stabilizer plate located within the cylinder defined by the cutting plates, said stabilizer plate having a lower horizontal surface fixed at about the same level as the lower surface of the base plate.

2. The hole cutter of claim 1, further comprising a plurality of arced supports, each of said arced supports providing a rigid mount to a corresponding cutting plate and communicating with a corresponding fixed screw rod so that rotation of the screw results in vertical motion of both the arced support and the cutting plate.

3. The hole cutter of claim 1, where the top of each of the fixed screw rods comprises a driver adapter.

4. The hole cutter of claim 1, further comprising a cup for containing a turf cylinder extracted by the hole cutter.

5. The hole cutter of claim 1, where the stabilizer plate is secured in place to the horizontal bracket via a connecting rod, and where the stabilizer plate includes bearings for supporting the lower end of each fixed drive screw.
